(19) United States
(12) Patent Application Publication
(10) Pub. No.: US 2021/0104794 A1
(43) Pub. Date: Apr. 8, 2021

(54) LITHIUM-AIR BATTERY PACKAGE

(71) Applicants: HYUNDAI MOTOR COMPANY, Seoul (KR); KIA MOTORS CORPORATION, Seoul (KR)

(72) Inventors: Gwang Seok OH, Seoul (KR); Won Keun KIM, Seoul (KR); Jong Chan SONG, Suwon-si (KR); Ji Yong LEE, Seongnam-si (KR); Eun Ji KWON, Hwaseong-si (KR)

(73) Assignees: HYUNDAI MOTOR COMPANY, Seoul (KR); KIA MOTORS CORPORATION, Seoul (KR)

(21) Appl. No.: 17/023,618

(22) Filed: Sep. 17, 2020

(30) Foreign Application Priority Data
Oct. 2, 2019 (KR) 10-2019-0121958

(51) Int. Cl. H01M 12/06; H01M 2/26; H01M 2/10; H01M 4/66

(52) U.S. Cl. CPC H01M 12/06; H01M 4/661; H01M 2/105; H01M 2/266

(57) ABSTRACT

A cylindrical lithium-air battery package includes: a cylindrical unit cell formed by cylindrically winding components of the lithium-air battery and a current collection case to accommodate the cylindrical unit cell. The cylindrical lithium-air battery package enables smooth supply and diffusion of air to cathodes included in cylindrical unit cell and enables efficient current collection by packing the cylindrical unit cells in a current collection case so that air supply and current collection is performed through both sides rather than through the circumferential surface of the cylindrical unit cells.

### CROSS REFERENCE TO RELATED APPLICATION

This application claims priority to and the benefit of Korean Patent Application No. 10-2019-0121958, filed Oct. 2, 2019, the entire contents of which are incorporated herein by reference.

### FIELD

The present disclosure relates to a lithium-air battery package and, more particularly, to a cylindrical lithium-air battery package enabling smooth supply and diffusion of air to a cathode and enabling efficient current collection.

### BACKGROUND

The statements in this section merely provide background information related to the present disclosure and may not constitute prior art.

A lithium-air battery is a battery system using lithium for the anode and the oxygen in the air that is an active material for the cathode (air electrode) and studies for using the lithium-air electrode as the power of eco-friendly vehicles such as an electric vehicle have been conducted in consideration of the advantages of the lithium-air battery that it is inexpensive and has an eco-friendly characteristic and excellent safety.

According to the lithium-air battery, in a discharge reaction, the lithium metal at the anode oxidizes, so lithium ions and electrons are produced, the lithium ions move to the cathode through an electrolyte, and the electrons move to the cathode through an external wire or a current collector. Further, the oxygen contained in the external air flows to the cathode, is reduced by the electrons, and reacts with the lithium ions, whereby Li₂O₂ is produced.

For reference, a charge reaction of the lithium-air battery progresses as an opposite reaction to the discharge reaction.

Such a lithium-air electrode is manufactured by packaging several unit cells in various ways, and as an example of the related art, a metal-battery including several unit cells packaged in a cylindrical shape.

The most important matter when packaging the lithium-air battery in a cylindrical shape is that air should be supplied well to the cathodes in all unit cells constituting the lithium-air battery and current collection should be efficiently performed in order to increase energy density of the lithium-air battery.

However, we have discovered that in the metal-battery of the related art, since the current collectors of the unit cells packaged in a cylindrical shape are positioned around the cylinder, it is difficult to conductively connect the current collectors of the unit cells when stacking the cylindrical unit cells in close contact with each other.

Further, in the metal-battery, since the unit cells cylindrically packaged are longitudinally and radially brought in close contact with each other when they are stacked, it is difficult to secure an air path for the cathode included in each of the unit cells. Accordingly, the air is not supplied well to the cathodes existing in each of the unit cells.

### SUMMARY

The present disclosure provides a cylindrical lithium-air battery package that includes cylindrical unit cells formed by cylindrically winding components of the lithium-air battery, enables smooth supply and diffusion of air to cathodes included in cylindrical unit cell, and enables efficient current collection by packing the cylindrical unit cells in a current collection case so that air supply and current collection is performed through both sides rather than through the circumferential portion of the cylindrical unit cells.

A lithium-air battery package according to an aspect of the present disclosure includes: a cylindrical unit cell formed by cylindrically winding an anode stacked on a first side of a membrane, a cathode stacked on a second side of the membrane, an anode current collector stacked on an outer side of the anode, and a cathode current collector stacked on an outer side of the cathode; and a current collection case configured to receive the cylindrical unit cell. In particular, the current collection case includes: an outer casing surrounding a circumferential portion of the cylindrical unit cell to be able to insulate the cylindrical unit cell, a cathode current collection plate attached to a top of the outer casing, positioned over a top of the cylindrical unit cell, and conductively connected with the cathode current collector exposed through the top of the cylindrical unit cell, and an anode current collection plate attached to a bottom of the outer casing, positioned under a bottom of the cylindrical unit cell, and conductively connected with the anode current collector exposed through a bottom of the cylindrical unit cell.

In one form, a cathode current collection tap protruding outside through the top of the cylindrical unit cell and being conductively in contact with the cathode current collection plate may integrally extend from an upper end of the cathode current collector. In another form, an anode current collection tap protruding outside through the bottom of the cylindrical unit cell and being conductively in contact with the anode current collection plate may integrally extend from a lower end of the anode current collector.

In some forms of the present disclosure, the cathode current collection tap may integrally extend in one, or two or more band shapes from the upper end of the cathode current collector, and the anode current collection tap may integrally extend in one, or two or more band shapes from the lower end of the anode current collector.

In some forms of the present disclosure, the cylindrical unit cell may be wound with a predetermined height such that air can be diffused throughout an area of the cathode after air is supplied to the cathode exposed to the outside through the top and bottom of the cylindrical unit cell.

In some forms, the anode current collection tap of the anode current collector may employ a copper foil.

In some forms, the cathode current collector and the cathode current collection tap may be manufactured in a metal foam or metal mesh structure that has porous air diffusion paths for air diffusion for the cathode.

In some forms, the outer casing may be made of an insulating polymer or a metal material coated with an insulating polymer.

In some forms, the cathode current collection plate and the anode current collection plate may be conductive metal plates having several air-through holes for airflow.

In another form, a stacking cap may protrude upward from a center of the cathode current collection plate to form an air passage between the cathode current collection plate and the anode current collection plate that face each other when the current collection cases each having the cylindrical unit cell are stacked.

In other form of the present disclosure, a lithium-air battery package includes: a cylindrical unit cell formed by an anode stacked on a first side of a membrane, a cathode stacked on a second side of the membrane, an anode current collector stacked on an outer side of the anode, and a cathode current collector stacked on an outer side of the cathode, where the anode, the cathode, the anode current collector and the cathode current collector are configured to cylindrically wind around a cathode current collection rod and form a close contact with an outer side of the cathode current collector; and a current collection case configured to accommodate the cylindrical unit cell and including: an outer casing surrounding a circumferential portion of the cylindrical unit cell to be able to insulate the cylindrical unit cell, a cathode current collection plate attached to a top of the outer casing, positioned over a top of the cylindrical unit cell, and conductively connected with the cathode current collection rod exposed through the top of the cylindrical unit cell, and an anode current collection plate attached to a bottom of the outer casing, positioned under a bottom of the cylindrical unit cell, and conductively connected with the anode current collector exposed through a bottom of the cylindrical unit cell.

In some forms, the cathode current collection rod may be positioned at a center of the cylindrical unit cell, and an upper end of the cathode current collection rod is configured to protrude outside through the top of the cylindrical unit cell to be conductively in contact with the cathode current collection plate. An anode current collection tap protruding outside through the bottom of the cylindrical unit cell and being conductively in contact with the anode current collection plate may integrally extend from a lower end of the anode current collector.

The anode current collection tap may integrally extend in one, or two or more band shapes from the lower end of the anode current collector.

The cylindrical unit cell may be wound with a predetermined height such that air can be diffused throughout an area of the cathode after air is supplied to the cathode exposed to the outside through the top and bottom of the cylindrical unit cell.

The anode current collection tap of the anode current collector may employ a copper foil.

The cathode current collector may be manufactured in a metal foam or metal mesh structure that has porous air diffusion paths for air diffusion for the cathode.

The outer casing may be made of an insulating polymer or a metal material coated with an insulating polymer.

The cathode current collection plate and the anode current collection plate may be conductive metal plates having several air-through holes for airflow.

A stacking cap may protrude upward from a center of the cathode current collection plate to form an air passage between the cathode current collection plate and the anode current collection plate that face each other, and conductively comes in contact with the cathode current collection rod when the current collection cases each having the cylindrical unit cell are stacked.

In one form, a current collection rod insertion groove is formed on a bottom surface of the stacking cap, and an upper end of the cathode current collection rod is inserted in the current collection rod insertion groove while establishing an electrically conductive contact with the bottom surface of the stacking cap.

An insulating film that passes only air may be inserted between the top of the cylindrical unit cell and a bottom of the cathode current collection plate and between the bottom of the cylindrical unit cell and a top of the anode current collection plate.

The present disclosure provides the following effects from the objects described above.

First, a cylindrical unit cell is formed by cylindrically winding components of a lithium-air battery and the cylindrical unit cell is packaged in the current collection case, which has a structure through which air circulates up and down and left and right, whereby air can be supplied and diffused to the cathode through both sides (top and bottom) rather than through the circumferential surface of the cylindrical unit cell.

Second, a cylindrical unit cell is formed by cylindrically winding components of a lithium-air battery and a cathode current collection tap of the cathode current collector and an anode current collection tap of the anode current collector protrude outside through both sides (top and bottom) rather than through the circumferential surface of the cylindrical unit cell, whereby current collection can be efficiently performed through both sides of the cylindrical unit cell.

Third, even though the current collection cases each having the cylindrical unit cell 100 therein are stacked up and down and left and right, up-down airflow is induced by air-through holes formed through the current collection case, and left-right airflow is induced by the left-right air passages formed between the current collection cases, so air can be supplied and circulated well to the cathode.

Fourth, the current collection cases each having the cylindrical unit cell therein are stacked up and down and left and right such that several cylindrical unit cells are connected in series by the current collection cases, whereby current collection for the several cylindrical unit cells can be performed well.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIGS. 1 and 2 are perspective views showing a process of manufacturing a cylindrical unit cell of components of a lithium-air battery package in one form of the present disclosure;

FIGS. 3 and 4 are perspective views showing another process of manufacturing a cylindrical unit cell of components of a lithium-air battery package according to another form of the present disclosure;

FIG. 5 is a perspective view showing a current collection case of the components of the lithium-air battery package in one form of the present disclosure;

FIG. 6 is a cross-sectional view showing a package completion state of a lithium-air battery package according to one form of the present disclosure;

FIGS. 7 and 8 are perspective view showing an example of a process of manufacturing a cylindrical unit cell of components of a lithium-air battery package according to another form of the present disclosure;

FIG. 9 is a separate perspective view showing a cylindrical unit cell and a current collection case of the lithium-air battery package according to another form of the present disclosure;

FIGS. 10 and 11 are cross-sectional views showing a package completion state of a lithium-air battery package according to another form of the present disclosure; and

FIG. 12 is a cross-sectional view showing an example in which lithium-air battery packages are stacked up and down, and left and right.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Hereinafter, exemplary forms of the present disclosure will be described in detail with reference to the accompanying drawings.

A lithium-air battery package according to one form of the present disclosure is described hereafter.

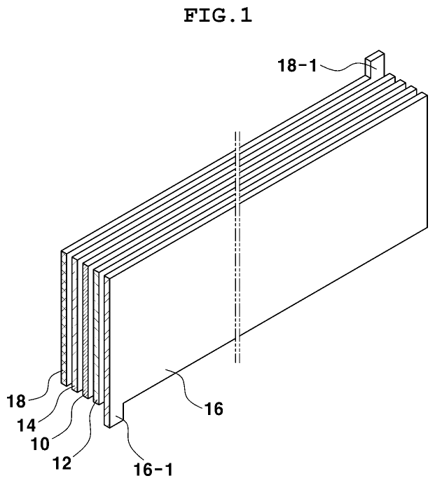

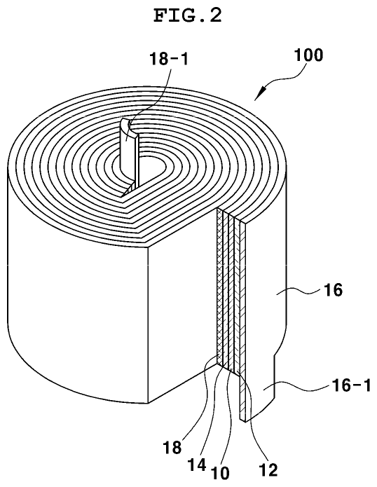

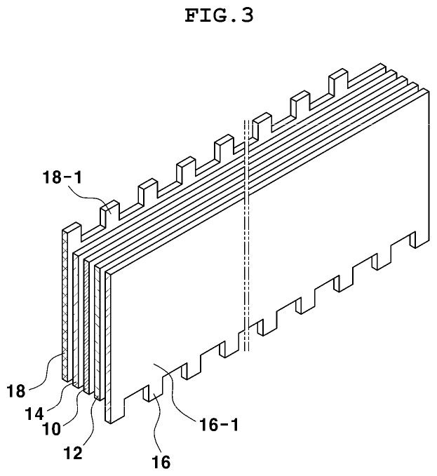

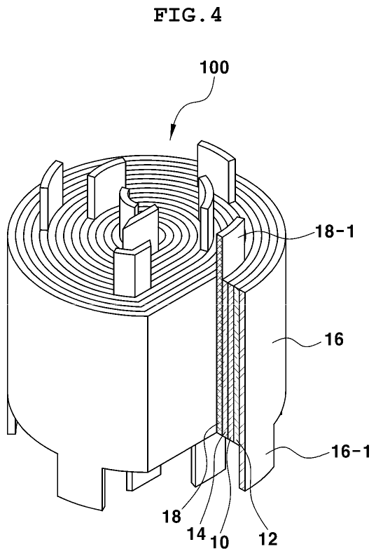

FIGS. 1 and 2 are perspective view showing an example of a process of manufacturing a cylindrical unit cell of components of a lithium-air battery package in one form of the present disclosure and FIGS. 3 and 4 are perspective views showing another example of a process of manufacturing a cylindrical unit cell of components of a lithium-air battery package according to another form of the present disclosure, in which reference numeral 10 indicates a membrane in the figures.

The membrane 10 is cut with predetermined length and height and is impregnated with an electrolyte.

In general, an anode 12 of a lithium foil type is attached to a first side of the membrane 10 and an active material such as a CNT-based material, a graphite-based material, or an existing conducive Ketjen Black (KB) or Acetylene Black (AB) is stacked on a second side as a cathode 14 that is an air electrode.

An anode current collector 16 of a copper foil type is stacked on the outer side of the anode 12 and a cathode current collector 18 made of porous conductive metal (e.g., nickel and stainless steel) is stacked on the outer side of the cathode 14 for air diffusion.

When the anode 12 and the cathode 14 are stacked on both sides of the membrane 10, respectively, they may be stacked with a length and a height that are the same as or smaller than the length and height of the membrane 10.

In particular, an anode current collection tap 16-1 integrally extends from the lower end of the anode current collector 16.

When the copper foil that is used as the anode current collector 16, it is cut such that the anode current collection tap 16-1 made of the same material integrally extends from the lower end of the anode current collector 16, whereby the anode current collection tap 16-1 may integrally extend in one, or two or more rectangular band shapes from the lower end of the anode current collector 16.

Further, a cathode current collection tap 18-1 integrally extends from the upper end of the cathode current collector 18.

When the cathode current collector 18 is formed by forming in a metal foam type having porous air diffusion paths inside and outside using conductive metal (e.g., nickel and stainless steel) or is manufactured in a metal mesh type having porous air diffusion paths using conductive metal (e.g., nickel and stainless steel), a cathode current collection tap 18-1 further integrally extends from the upper end of the cathode current collector 18.

Accordingly, the cathode current collection tap 18-1 may extend in one, or two or more rectangular band shapes from the upper end of the cathode current collector 18.

As described above, the anode 12 stacked on a first side of the membrane 10, the cathode 14 stacked on a second side of the membrane 10, the anode current collector 16 stacked on the outer side of the anode 12, and the cathode current collector 18 stacked on the outer side of the cathode 14 are arrange flat and wound in a cylindrical shape, whereby a cylindrical unit cell 100 that is one unit constituting a lithium-air electrode is completed.

The cylindrical unit cell 100 is wound with a predetermined height such that air can be diffused throughout the area of the cathode 14 after air is supplied to the cathode 14 exposed to the outside through the top and bottom of the cylindrical unit cell 100. The reason is because if the height of the cylindrical unit cell 100 is too large, air is not diffused well throughout the area of the cathode 14 even though air is supplied.

In this case, the cathode current collection tap 18-1 protrudes outside through the top of the cylindrical unit cell 100 and the anode current collection tap 16-1 protrudes outside through the bottom of the cylindrical unit cell 100.

In one form, as shown in FIG. 2, one cathode current collection tap 18-1 and one anode current collection tap 16-1 may protrude through the top and the bottom of the cylindrical unit cell 100, respectively. In another form, as shown in FIG. 4, a plurality of cathode current collection taps 18-1 and a plurality of anode current collection taps 16-1 may protrude through the top and the bottom of the cylindrical unit cell 100, respectively.

As described above, since the cathode current collection tap 18-1 of the cathode current collector 18 and the anode current collection tap 16-1 of the anode current collector 16 protrude outside through both sides (e.g., the top and the bottom) rather than through the circumferential surface of the cylindrical unit cell 100, current collection can be sufficiently performed through both sides of the cylindrical unit cell 100.

In another form, the lithium-air battery package includes a current collection case 200 in which the cylindrical unit cell 100 is disposed.

The current collection case 200 is manufactured to have a current collection structure for discharging and charging the cylindrical unit cell 100 and a stacking structure for stacking the cylindrical unit cell 100 in an up and down direction, and a left and right direction.

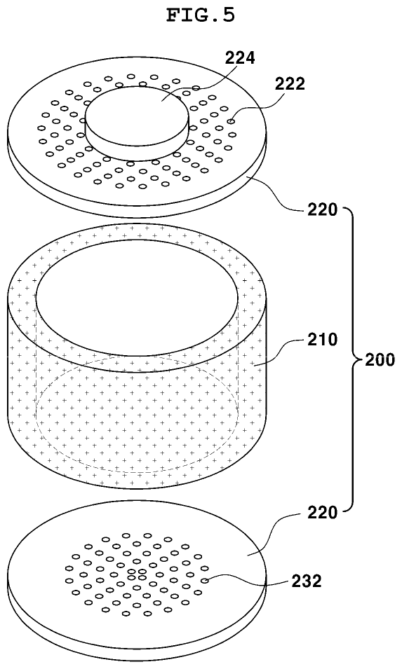

To this end, the current collection case 200, as shown in FIG. 5, includes an outer casing 210 surrounding the circumferential portion of the cylindrical unit cell 100 to be able to insulate it, a cathode current collection plate 220 attached to the top of the outer casing 210, and an anode current collection plate 230 attached to the bottom of the outer casing 210.

The outer casing 210 is made of an insulating polymer or a metal material coated with an insulating polymer to inhibit or prevent an electrical short between the cathode current collection plate 220 and the anode current collection plate 230, and the outer casing 210 is in close contact with the circumferential surface of the cylindrical unit cell 100.

In other words, the cylindrical unit cell 100 is inserted in the outer casing 210 and the circumferential portion of the cylindrical unit cell 100 is in close contact with the inner side of the outer casing 210.

The cathode current collection plate 220 is attached to the top of the outer casing 210, and positioned over the top of the cylindrical unit cell 100. And the cathode current collection plate 220 is conductively connected to the cathode current collector 18 exposed through the top of the cylindrical unit cell 100.

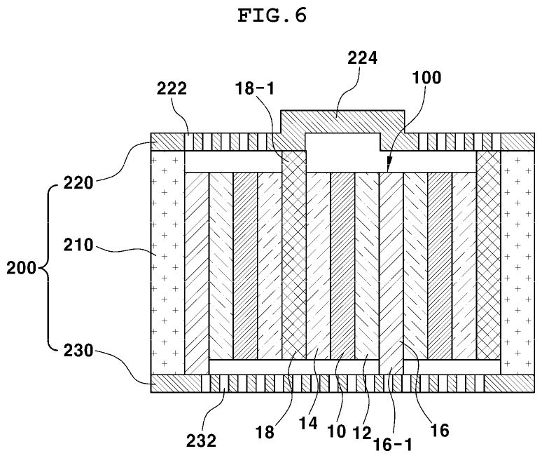

In more detail, as shown in FIG. 6, the cathode current collection tap 18-1 integrally formed at the upper end of the cathode current collector 18 and protruding outside through the top of the cylindrical unit cell 100 is conductively in contact with the bottom of the cathode current collection plate 220.

The anode current collection plate 230 attached to the bottom of the outer casing 210 is positioned under the bottom of the cylindrical unit cell 100, and is conductively connected to the anode current collector 16 exposed through the bottom of the cylindrical unit cell 100.

In more detail, as shown in FIG. 6, the anode current collection tap 16-1 integrally formed at the lower end of the anode current collector 16 and protruding outside through the bottom of the cylindrical unit cell 100 is conductively in contact with the top of the anode current collection plate 230.

The cathode current collection plate 220 and the anode current collection plate 230 of the current collection case 200 are conductive plates having several air-through holes 222 and 232 for air flow so that air is supplied and circulated to the cathode 14 and the cathode current collector 18, respectively.

A stacking cap 224 protrudes upward from the center of the cathode current collection plate 220 of the current collection case 200.

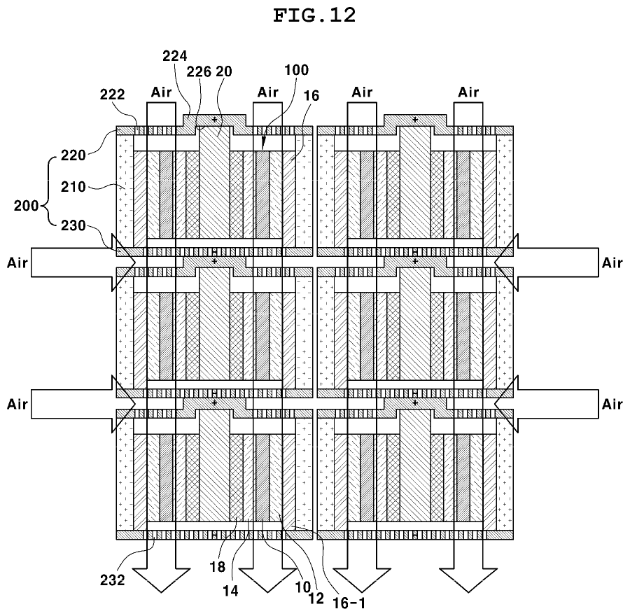

Accordingly, as shown in FIG. 12, when the current collection cases 200 each having the cylindrical unit cell 100 therein are stacked up and down and left and right, an air passage 240 is formed between the cathode current collection plate 220 and the anode current collection plate 230 that face each other by the height of the stacking cap 224.

Accordingly, even though the current collection cases 200 each having the cylindrical unit cell 100 therein are stacked up and down and left and right, air can circulate through the current collection cases 200 stacked left and right through the air passages 240 and the circulating air can be supplied to the cathode 14 and the cathode current collector 18 through the air-through holes 222 of the cathode current collection plate 220.

As described above, the cylindrical unit cell 100 is packaged in the current collection case 200, which has a structure through which air circulates up and down and left and right, whereby air can be supplied and diffused to the cathode through both sides (top and bottom) rather than through the circumferential surface of the cylindrical unit cell 100.

In other words, even though the current collection cases 200 each having the cylindrical unit cell 100 therein are stacked up and down and left and right, up-down airflow is induced by the air-through holes 222 and 232 formed through the cathode current collection plate 220 and the anode current collection plate 230 of the current collection case 200, and left-right airflow is induced by the left-right air passages formed between the current collection cases 200, so air can be supplied and circulated well to the cathode 14.

Further, the current collection cases 200 each having the cylindrical unit cell 100 therein are stacked up and down and left and right such that several cylindrical unit cells 100 are connected in series by the current collection cases 200, as shown in FIG. 12, whereby current collection for the several cylindrical unit cells 100 can be performed well.

A lithium-air battery package according to another form of the present disclosure is described hereafter.

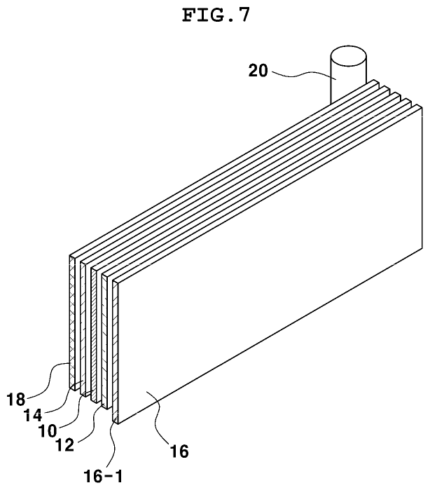

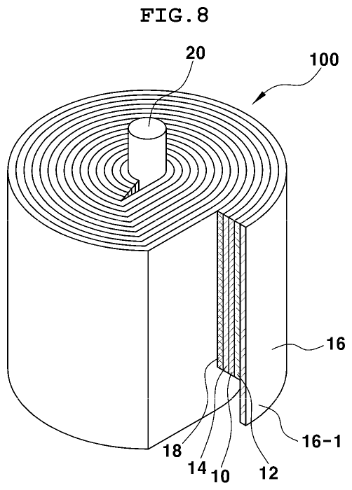

FIGS. 7 and 8 are perspective view showing an example of a process of manufacturing a cylindrical unit cell of components of a lithium-air battery package according to another form of the present disclosure, in which reference numeral 20 indicates a cathode current collection rod.

The lithium-air battery package according to another form of the present disclosure is characterized in that the cylindrical unit cell 100 employs the cathode current collection rod 20 as a component for cathode current collection.

Referring to FIG. 7, a cylindrical unit cell 100 according to another form of the present disclosure is completed as one unit constituting a lithium-air battery by arranging flat an anode 12 stacked on a first side of a membrane 10, a cathode 14 stacked on a second side of the membrane 10, an anode current collector 16 stacked on the outer side of the anode 12, and a cathode current collector 18 stacked on the outer side of the cathode 14, and then winding them with the cathode current collection rod 20 in close contact with the outer side of the cathode current collector 18.

The membrane 10 is cut with predetermined length and height and is impregnated with an electrolyte.

In general, an anode 12 of a lithium foil type is layered and attached to a first side of the membrane 10 and an active material such as a CNT-based material, a graphite-based material, or an existing conducive Ketjen Black (KB) or Acetylene Black (AB) is stacked on a second side as a cathode 14 that is an air electrode.

An anode current collector 16 of a copper foil type is stacked on the outer side of the anode 12 and a cathode current collector 18 made of porous conductive metal (e.g., nickel and stainless steel) is stacked on the outer side of the cathode 14 for air diffusion.

When the anode 12 and the cathode 14 are stacked on both sides of the membrane 10, respectively, they may be stacked with a length and a height that are the same as or smaller than the length and height of the membrane 10.

In particular, an anode current collection tap 16-1 integrally extends from the lower end of the anode current collector 16.

When the copper foil that is used as the anode current collector 16, it is cut such that the anode current collection tap 16-1 made of the same material integrally extends from the lower end of the anode current collector 16, whereby the anode current collection tap 16-1 may integrally extend in one, or two or more rectangular band shapes from the lower end of the anode current collector 16.

The cathode current collector 18 may be formed by forming in a metal foam type having porous air diffusion paths inside and outside using conductive metal (e.g., nickel and stainless steel) or is manufactured in a metal mesh type having porous air diffusion paths using conductive metal (e.g., nickel and stainless steel).

As described above, since the cathode current collection rod 20 being conductively in contact with the cathode current collector 18 and the anode current collection tap 16-1 of the anode current collector 16 protrude outside through both sides (e.g., the top and the bottom) rather than through the circumferential surface of the cylindrical unit cell 100, current collection can be sufficiently performed through both sides of the cylindrical unit cell 100.

The lithium-air battery package according to another form of the present disclosure also includes a current collection case 200 in which the cylindrical unit cell 100 is disposed.

The current collection case 200 is manufactured to have a current collection structure for discharging and charging the cylindrical unit cell 100 and a stacking structure for stacking the cylindrical unit cell 100 up and down and left and right.

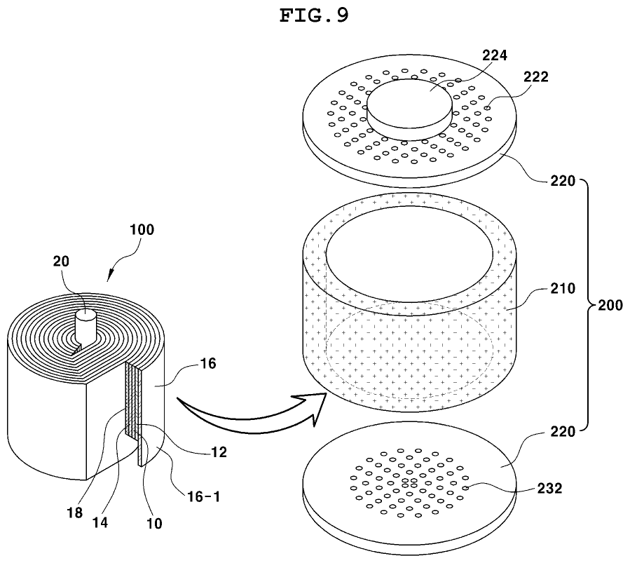

To this end, the current collection case 200, as shown in FIG. 9, includes an outer casing 210 surrounding the circumferential portion of the cylindrical unit cell 100 to be able to insulate it, a cathode current collection plate 220 attached to the top of the outer casing 210, and an anode current collection plate 230 attached to the bottom of the outer casing 210.

The outer casing 210 is made of an insulating polymer or a metal material coated with an insulating polymer to inhibit or prevent an electrical short between the cathode current collection plate 220 and the anode current collection plate 230, and is in close contact with the circumferential surface of the cylindrical unit cell 100.

In other words, the cylindrical unit cell 100 is inserted in the outer casing 210 and the circumferential portion of the cylindrical unit cell 100 is in close contact with the inner side of the outer casing 210.

The cathode current collection plate 220 is attached to the top of the outer casing 210, is positioned over the top of the cylindrical unit cell 100, and is conductively connected to the cathode current collection rod 20 exposed through the top of the cylindrical unit cell 100.

A stacking cap 224 protrudes upward from the center of the cathode current collection plate 220 of the current collection case 200, and a current collection rod insertion groove 226 is formed on a bottom surface of the stacking cap 224. The upper end of the cathode current collection rod 20 is inserted in the current collection rod insertion groove 226 and thus forms an electrically conductive contact with the stacking cap 224.

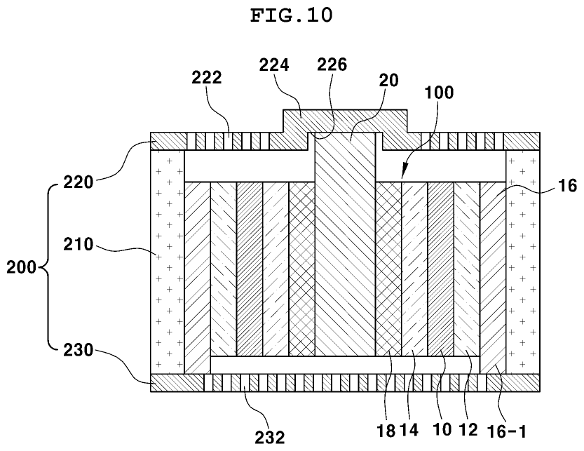

Accordingly, as shown in FIG. 10, the upper end of the cathode current collection rod 20 protruding outside through the top of the cylindrical unit cell 100 is conductively inserted in the current collection rod insertion groove 226 formed on the stacking cap 224 in contact with it.

The anode current collection plate 230 is attached to the bottom of the outer casing 210, is positioned under the bottom of the cylindrical unit cell 100, and is conductively connected to the anode current collector 16 exposed through the bottom of the cylindrical unit cell 100.

In more detail, as shown in FIG. 10, the anode current collection tap 16-1 integrally formed at the lower end of the anode current collector 16 and protruding outside through the bottom of the cylindrical unit cell 100 is conductively in contact with the top of the anode current collection plate 230.

The cathode current collection plate 220 and the anode current collection plate 230 of the current collection case 200 are conductive plates having several air-through holes 222 and 232 for air flow so that air is supplied and circulated to the cathode 14 and the cathode current collector 18, respectively.

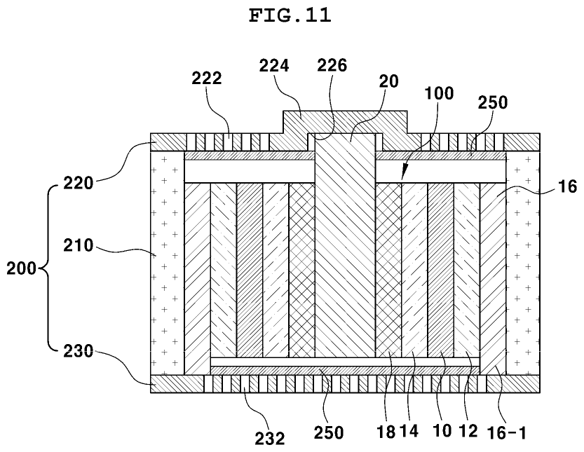

Meanwhile, as shown in FIG. 11, an insulating film 250 that passes only air may be further inserted between the top of the cylindrical unit cell 100 and the bottom of the cathode current collection plate 220 and between the bottom of the cylindrical unit cell 100 and the top of the anode current collection plate 230.

The insulating film 250 passes only air so that air can be supplied well to the cathode and prevents volatilization and leakage of the electrolyte of the membrane 10 included in the cylindrical unit cell 100.

Similarly, in another form of the present disclosure, as shown in FIG. 12, the current collection cases 200 each having the cylindrical unit cell 100 therein are stacked up and down and left and right, an air passage 240 is formed between the cathode current collection plate 220 and the anode current collection plate 230 that face each other by the height of the stacking cap 224.

Accordingly, even though the current collection cases 200 each having the cylindrical unit cell 100 therein are stacked up and down and left and right, air can circulate through the current collection cases 200 stacked left and right through the air passages 240 and the circulating air can be supplied to the cathode 14 and the cathode current collector 18 through the air-through holes 222 of the cathode current collection plate 220.

As described above, the cylindrical unit cell 100 is packaged in the current collection case 200, which has a structure through which air circulates up and down and left and right, whereby air can be supplied and diffused to the cathode through both sides (top and bottom) rather than through the circumferential surface of the cylindrical unit cell 100.

In other words, even though the current collection cases 200 each having the cylindrical unit cell 100 therein are stacked up and down and left and right, up-down airflow is induced by the air-through holes 222 and 232 formed through the cathode current collection plate 220 and the anode current collection plate 230 of the current collection case 200, and left-right airflow is induced by the left-right air-through holes 240 formed between the current collection cases 200, so air can be supplied and circulated well to the cathode 14.

Further, the current collection cases 200 each having the cylindrical unit cell 100 therein are stacked up and down and left and right such that several cylindrical unit cells 100 are connected in series by the current collection cases 200, as shown in FIG. 12, whereby current collection for the several cylindrical unit cells 100 can be performed well.

What is claimed is:

1. A lithium-air battery package comprising:
a cylindrical unit cell formed by cylindrically winding: an anode stacked on a first side of a membrane, a cathode stacked on a second side of the membrane, an anode current collector stacked on an outer side of the anode, and a cathode current collector stacked on an outer side of the cathode; and
a current collection case configured to receive the cylindrical unit cell and including:
an outer casing configured to surround a circumferential portion of the cylindrical unit cell and insulate the cylindrical unit cell;
a cathode current collection plate attached to a top of the outer casing and conductively connected with the cathode current collector exposed through a top of the cylindrical unit cell; and
an anode current collection plate attached to a bottom of the outer casing and conductively connected with the anode current collector exposed through a bottom of the cylindrical unit cell.

2. The lithium-air battery package of claim 1, further comprising:
a cathode current collection tap protruding outside through the top of the cylindrical unit cell and being conductively in contact with the cathode current collection plate; and
an anode current collection tap protruding outside through the bottom of the cylindrical unit cell and being conductively in contact with the anode current collection plate,
wherein the cathode current collection tap is configured to integrally extend from an upper end of the cathode current collector, and the anode current collection tap is configured to integrally extend from a lower end of the anode current collector.

3. The lithium-air battery package of claim 2, wherein the cathode current collection tap is configured to integrally extend in at least one band shape from the upper end of the cathode current collector, and the anode current collection tap is configured to integrally extend in at least one band shape from the lower end of the anode current collector.

4. The lithium-air battery package of claim 2, wherein the anode current collection tap of the anode current collector employs a copper foil.

5. The lithium-air battery package of claim 2, wherein the cathode current collector and the cathode current collection tap are manufactured in a metal foam or a metal mesh structure that has porous air diffusion paths for air diffusion for the cathode.

6. The lithium-air battery package of claim 1, wherein the cylindrical unit cell is wound with a predetermined height such that air is diffused throughout an area of the cathode after air is supplied to the cathode exposed to the outside through the top and the bottom of the cylindrical unit cell.

7. The lithium-air battery package of claim 1, wherein the outer casing is made of an insulating polymer or a metal material coated with an insulating polymer.

8. The lithium-air battery package of claim 1, wherein the cathode current collection plate and the anode current collection plate are conductive metal plates having several air-through holes for airflow.

9. The lithium-air battery package of claim 1, further comprising:
a stacking cap protruding upward from a center of the cathode current collection plate and configured to form an air passage between the cathode current collection plate and the anode current collection plate that face each other when a plurality of current collection cases each having the cylindrical unit cell are stacked.

10. A lithium-air battery package comprising:
a cylindrical unit cell formed by an anode stacked on a first side of a membrane, a cathode stacked on a second side of the membrane, an anode current collector stacked on an outer side of the anode, and a cathode current collector stacked on an outer side of the cathode, wherein the anode, the cathode, the anode current collector and the cathode current collector are configured to cylindrically wind around a cathode current collection rod and form a close contact with an outer side of the cathode current collector; and
a current collection case configured to accommodate the cylindrical unit cell and including:
an outer casing configured to surround a circumferential portion of the cylindrical unit cell and insulate the cylindrical unit cell;
a cathode current collection plate attached to a top of the outer casing and conductively connected with the cathode current collection rod exposed through a top of the cylindrical unit cell; and
an anode current collection plate attached to a bottom of the outer casing and conductively connected with the anode current collector exposed through a bottom of the cylindrical unit cell.

11. The lithium-air battery package of claim 10, wherein:
the cathode current collection rod is positioned at a center of the cylindrical unit cell,
an upper end of the cathode current collection rod is configured to protrude outside through the top of the cylindrical unit cell and conductively in contact with the cathode current collection plate, and
an anode current collection tap protruding outside through the bottom of the cylindrical unit cell is conductively in contact with the anode current collection plate and configured to integrally extend from a lower end of the anode current collector.

12. The lithium-air battery package of claim 11, wherein the anode current collection tap is configured to integrally extend in at least one band shape from the lower end of the anode current collector.

13. The lithium-air battery package of claim 11, wherein the anode current collection tap of the anode current collector employs a copper foil.

14. The lithium-air battery package of claim 10, wherein the cylindrical unit cell is wound with a predetermined height such that air can be diffused throughout an area of the cathode after air is supplied to the cathode exposed to the outside through the top and the bottom of the cylindrical unit cell.

15. The lithium-air battery package of claim 10, wherein the cathode current collector is manufactured in a metal foam or a metal mesh structure, which has porous air diffusion paths for air diffusion for the cathode.

16. The lithium-air battery package of claim 10, wherein the outer casing is made of an insulating polymer or a metal material coated with an insulating polymer.

17. The lithium-air battery package of claim 10, wherein the cathode current collection plate and the anode current collection plate are conductive metal plates having several air-through holes for airflow.

18. The lithium-air battery package of claim 10, wherein:
a stacking cap is configured to protrude upward from a center of the cathode current collection plate and form an air passage between the cathode current collection plate and the anode current collection plate that face each other, and
the stacking cap is conductively in contact with the cathode current collection rod when a plurality of current collection cases each having the cylindrical unit cell are stacked.

19. The lithium-air battery package of claim 18, wherein a current collection rod insertion groove is formed on a bottom surface of the stacking cap, and an upper end of the cathode current collection rod is inserted in the current collection rod insertion groove while establishing an electrically conductive contact with the bottom surface of the stacking cap.

20. The lithium-air battery package of claim 10, wherein an insulating film configured to only passes air is inserted between the top of the cylindrical unit cell and a bottom of the cathode current collection plate and between the bottom of the cylindrical unit cell and a top of the anode current collection plate.
